(19) United States
(12) Patent Application Publication
(10) Pub. No.: US 2009/0050720 A1
(43) Pub. Date: Feb. 26, 2009

(54) Powderizing Apparatus and Powderizing Method

(75) Inventors: Masafumi Kikuchi, Kanagawa (JP); Akio Koyama, Kanagawa (JP); Kichinosuke Amimoto, Tokyo (JP); Takao Nishishita, Tokyo (JP); Yutaka Akahoshi, Tokyo (JP); Kazuko Ito, Tokyo (JP)

Correspondence Address: OSHA LIANG L.L.P., TWO HOUSTON CENTER, 909 FANNIN, SUITE 3500, HOUSTON, TX, 77010, US

(73) Assignee: Meiji University Legal Person, Tokyo (JP)

(21) Appl. No.: 11/662,985

(22) PCT Filed: Feb. 23, 2007
(86) PCT No.: PCT/JP2007/053395

§ 371 Date: Jul. 1, 2008

(30) Foreign Application Priority Data
Oct. 27, 2006 (JP) 2006-293317

(51) Int. Cl. B02C 17/00

(52) U.S. Cl. 241/24.1

(57) ABSTRACT

There is provided a powderizing apparatus and a method capable of powderizing target objects effectively. The powderizing apparatus includes a cylindrical container extending in a horizontal direction, a rotary shaft disposed along the axis of the cylindrical container, a plurality of rods disposed in parallel with respect to the rotary shaft in a position close to an inner wall of the cylindrical container and away from the rotary shaft, rod-fixing members for fixing the rods to the rotary shaft and hammering members provided on the respective rods.

### TECHNICAL FIELD

The present invention relates to a powderizing apparatus and a powderizing method for powderizing target objects.

### BACKGROUND ART

Along with the recent growth of recycling movements, it is required to recycle effectively composite materials composed of different kinds of materials such as plastic wall paper formed of a plastic layer of polyvinyl chloride or the like and a backing paper (pulp fiber layer) bonded to each other; tile carpet, soundproofing sheet, waterproofing sheet, construction site safety net and the like formed of plastic layer of polyvinyl chloride or the like and fiber layer of nylon or polyester bonded to each other, or fiber layer sandwiched between plastic layers, or fiber layer impregnated with a resin. To recycle such composite materials, composite materials have to be powderized, and the powder has to be separated for example, into resin powder and fibers according to the kind of the materials.

As effective powderizing methods of such composite materials, there are known the following methods; i.e., a cutting method disclosed in a patent document 1, a shredder method disclosed in a patent document 2, a shearing method and a rotating hammering method disclosed in patent documents 3 to 4. Further, rotating chain type crushing methods disclosed in patent documents 5 and 6 are known as apparatus for crushing hard materials such as waste concrete.

Patent document 1 Japanese Patent Application Laid-Open No. 2003-88772
Patent document 2 Japanese Patent Application Laid-Open No. 2003-24817
Patent document 3 Japanese Patent Application Laid-Open No. 2003-127140
Patent document 4 Japanese Patent Application Laid-Open No. 2003-320532
Patent document 5 Japanese Patent Application Laid-Open No. 2006-619898
Patent document 6 Japanese Patent Application Laid-Open No. 2000-189823

### DISCLOSURE OF THE INVENTION

### Problem to be Solved by the Invention

As a result of examination by the inventors of the present invention, it was found that conventional methods hardly powderized composite materials to 300 μm or smaller in a effective manner, and accordingly, the composite materials were hardly separated into each component element, for example, resin powder and fibers in a mechanical manner.

The inventors of the present invention found the following fact as a result of examination. That is, composite materials can be powderized to 300 μm or smaller by rotating a rotary shaft with hammering members such as hammers fixed thereto at an extremely high speed of, for example, 50 m/s or more, more preferably 100 m/s or more as a circumferential speed of the hammering members within a cylindrical container extending in a horizontal direction. However, such a circumferential speed is hardly obtained with conventional rotary-type apparatus and the power consumption thereof is also extremely large.

The present invention has been proposed in view of the above-mentioned problems. It is an object of the present invention to provide a powderizing apparatus and a method capable of powderizing target objects effectively.

### Means for Solving the Problems

A powderizing apparatus according to the present invention comprises a cylindrical container disposed in a substantially horizontal direction, a rotary shaft disposed along an axis of the cylindrical container, a plurality of rods each disposed in substantially parallel to the rotary shaft at a position away from the rotary shaft and close to an inner wall of the cylindrical container, a rod fixing member for fixing the plurality of rods to the rotary shaft, and a plurality of hammering members provided to each of the rods.

According to the present invention, each of the rods is disposed at a position close to the cylindrical container and away from the rotary shaft, and it is on the rods that the hammering members are provided. Therefore, compared to the case where the hammering members are disposed at a position close to the rotary shaft, the length of each of the hammering members in a rotational radial direction can be reduced, and accordingly air resistance due to the hammering members is reduced. Owing to this, the rotary shaft can be easily driven to rotate at a high speed, and electric power necessary for operation can be reduced.

Since the hammering members rotate at a high speed, the target object moves at a high speed between front end portion of the hammering members rotating at a high speed and the inner peripheral surface of the cylindrical container, and thereby the target object is swiftly powderized into 300 μm or smaller due to collision and friction.

Also, since each of the rods is provided with a plurality of hammering members, the rotation area of the hammering members can be formed to be long and continuous in the rotary shaft direction thereby performing effective powderizing operation.

When a composite material composed of various kinds of materials is powderized within such a powderizing apparatus, due to the influence of centrifugal force, light powder tends to gather in an inner side in the radial direction; i.e., a side closer to the rotary shaft within the cylindrical container, and heavy powder tends to gather in an outer side in the radial direction; i.e., a side closer to the inner wall of the cylindrical container.

Accordingly, rod-fixing members preferably have an opening or a cutout in a portion where a rotational radius is smaller at least than that of the rods, which allows gas and/or powder to flow in the axial direction of the rotary shaft.

Owing to this, the gas is allowed to flow in the axial direction in the inner side in the radial direction, and the light powder, which is separated in the inner side in the radial direction, can be selectively discharged to the outside along with the gas flow, thus separating function can be obtained as well.

In this case, particularly respective outlets for the powderized target object are preferably provided in the cylindrical container at positions where the distance from the rotary shaft is different from each other.

Owing to this arrangement, the heavy powder can be selectively discharged from the outer outlet in the radial direction; and the light powder can be selectively discharged from the inner outlet in the radial direction. Three or more outlets may be provided.

Among the plural outlets, the outlet with the largest distance from the rotary shaft is preferably formed in the peripheral surface of the cylindrical container.

Owing to this arrangement, such an advantage is obtained that the rolling powder can be discharged smoothly.

The rotary shaft is preferably rotated at a circumferential speed of 50 m/s or more, preferably 100 m/s or more, more preferably 120 m/s or more at the front end of the hammering members. Owing to this, the target object can be satisfactorily powderized.

The hammering members are preferably attached to each of the rods in a rotatable manner. Owing to this, such advantages can be obtained that the impact onto the hammering members caused by collision with the target object can be absorbed, unnecessary cut of fibers can be prevented, and consequently longer life of the hammering members is obtained.

It is preferable that three or more plate-like rod-fixing members are provided in the axial direction and each rod penetrates each rod-fixing member, and a plurality of hammering members are provided between each fixing member respectively. Owing to this, the structure is simplified and manufacturing and maintenance performance is enhanced.

Further, cooling means for cooling the container or cooling medium supply means for supply a cooling medium into the container is preferably provided. By supplying a cooling medium such as a liquid carbon oxide gas, a liquid nitrogen gas, water vapor, water mist, cooled air or the like into the container, the powder of the target object and the hammering members within the cylindrical container can be preferably prevented from being heated excessively. A target object pre-cooling device, which previously cools the target object to be supplied into the container, may also be preferably provided.

The inner wall of the container is preferably formed to be rugged state. When such rugged state is formed on the inner wall of the container, the target object collides with the rugged state and turbulent flow is created therewith to accelerate collision among the target objects themselves. Thus, powderizing the target object that is rolling along the inner wall of the container can be further promoted.

A powderizing method according to the present invention is a powderizing method of powderizing target object using the above-described powderizing apparatus.

### EFFECTS OF THE INVENTION

According to the present invention, a powderizing apparatus and a method capable of powderizing target objects effectively is provided.

### BRIEF DESCRIPTION OF THE DRAWINGS

FIG. 1 is a schematic diagram illustrating mainly a cross-sectional view in an axial direction of a powderizing apparatus according to a first embodiment.

FIG. 2 is a schematic diagram illustrating a cross-sectional view perpendicular to the axial direction in a vicinity of a cylindrical portion of the powderizing apparatus in FIG. 1.

FIGS. 3(a)-3(g) are perspective views showing various configurations of hammering members.

FIG. 4 is a schematic diagram illustrating a cross-sectional view perpendicular to the axial direction in a vicinity of a cylindrical portion of the powderizing apparatus according to a second embodiment.

FIG. 5 is an SEM photograph of a resin compound powder composed of polyvinyl chloride resin, plasticizer and filling material.

FIG. 6 is an SEM photograph of pulp.

### DESCRIPTION OF THE REFERENCE SYMBOLS

1 . . . powderizing apparatus, 10 . . . cylindrical container, 10b . . . outlet, 14a . . . inlet, 14c . . . outlet, 20 . . . rotary shaft, 30 . . . rod, 40 . . . rod fixing member, 42 . . . opening, 42a . . . cutout, 50 . . . hammering member

### BEST MODES FOR CARRYING OUT THE INVENTION

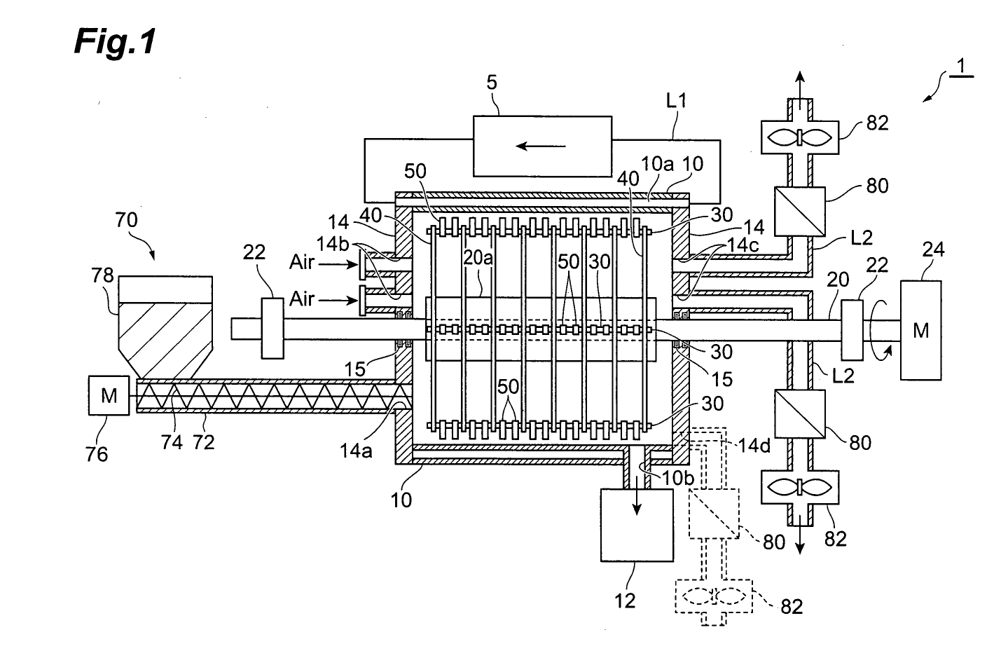

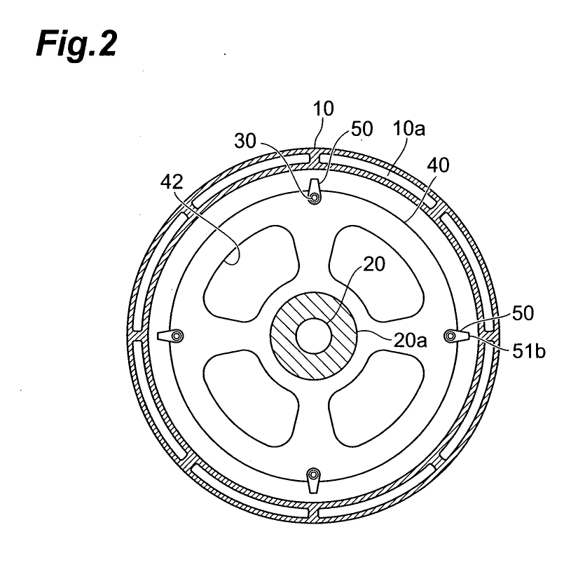

A first embodiment of the present invention will be described with reference to FIG. 1 and FIG. 2. A powderizing apparatus 1 according to the embodiment comprises mainly a cylindrical container 10, a rotary shaft 20, rods 30, rod fixing members 40 and hammering members 50 and the like.

The cylindrical container 10 is a cylinder-like container extending in a substantially horizontal direction. The cylindrical container 10 has a hollow jacket structure (cooling means) and is arranged so that a cooling medium such as water flows inside the jacket 10a. The jacket 10a is supplied with the cooling medium from a cooling-medium supply unit 5 through a line L1.

When the cylindrical container 10 does not have a jacket structure, the cylindrical container 10 may be cooled by water or the like dripped on the outer surface thereof. In order to facilitate maintenance operation, the cylindrical container 10 may be arranged to be separable into upper and lower parts and/or right and left parts. Disks 14 close both ends of the cylindrical container 10.

The rotary shaft 20 is disposed so as to penetrate the both disks 14 along the axis of the cylindrical container 10, preferably disposed to be coaxial with the axis of the cylindrical container 10. Bearings 15 capable of sealing gases and/or dust are provided at the portions where the rotary shaft 20 penetrates the disks 14.

Also, the rotary shaft 20 is supported rotatably about the axis thereof by bearings 22 each disposed at both outsides of the cylindrical container 10. Further, at one end of the rotary shaft 20, a motor 24 is connected so as to rotate the rotary shaft 20 at a high speed. As for the rotation speed, circumferential speed at the front end of the hammering member 50; i.e., linear speed at a maximum rotation radius of the hammering member 50 is 50 m/s or more, more preferably 100 m/s or more, further preferably, 120 m/s or more. It should be noted that ultra high-speed rotation of 200 m/s or more exhibits an intensified performance.

The rotary shaft 20 has a large diameter portion 20a where the diameter is enlarged within the cylindrical container 10, and rod-fixing members 40 shaped in circular frames are fixed in the enlarged diameter portion 20a so that the axis of the circular frame is coaxial with the rotary shaft 20. A number of rod-fixing members 40 are provided separated away from each other at predetermined intervals in the axial direction.

The rods 30 extend parallel with the axial direction penetrating each rod-fixing member 40. The rods 30 are fixed with respect to the rotary shaft 20 via the rod-fixing members 40.

A plurality of rods 30 are provided at symmetrical positions with respect to the rotary shaft 20 as shown in FIG. 2. Referring to FIG. 2, four rods are disposed 90° away from each other. However, two rods may be disposed at intervals of 180°, or three rods may be disposed at intervals of 120°. For the purpose of a high-speed rotation, it is preferable to dispose n-number rods at intervals of (360/n)° away from each other.

As shown in FIG. 1, the rods 30 are disposed between the enlarged diameter portion 20a of the rotary shaft 20 and the cylindrical container 10 so as to be away from the enlarged diameter portion 20a of the rotary shaft 20 and closer to the cylindrical container 10.

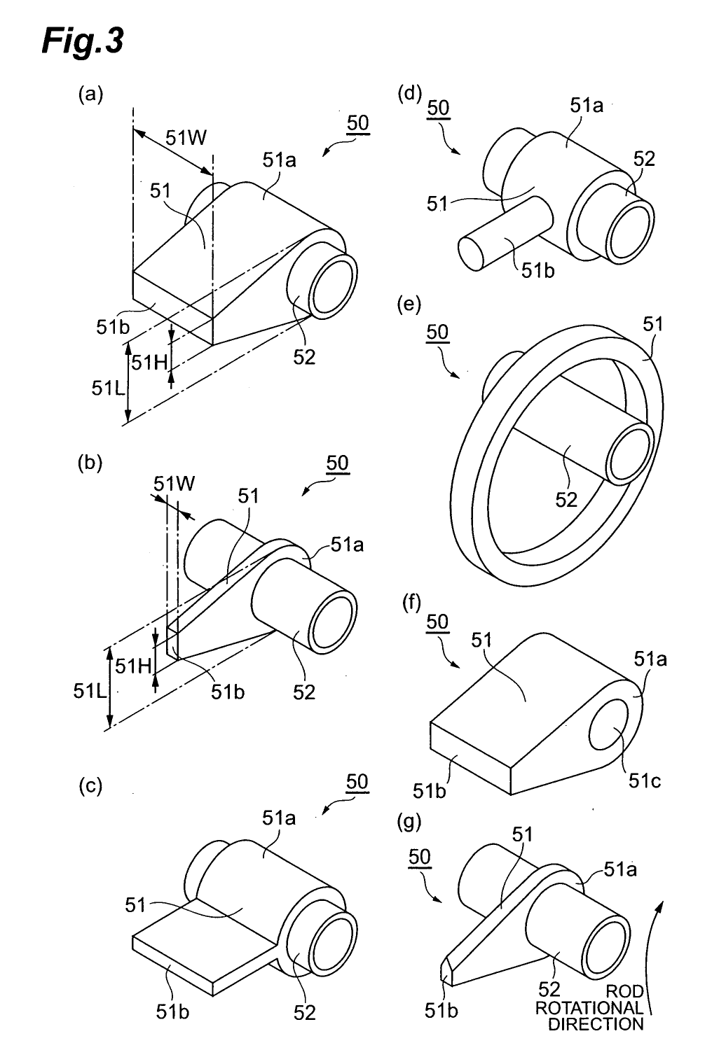

Each rod 30 has a plurality of hammering members 50 fixed thereto. A hammering member 50 has a body portion 51 and a pipe portion 52 as shown in FIG. 3(a). A root portion 51a of the body portion 51 is arranged to be penetrated by the pipe portion 52. The hammering members 50 are fixed to the rod 30 by the rod 30 penetration through the opening of the pipe portion 52. The body portion 51 is formed in a tapered shape as viewed from the axial direction of the pipe portion 52, in which the width 51H of the front-end portion 51b is smaller than the width 51L of the root portion 51a. The body portion 51 is arranged so that the length 51W in the axial direction of the pipe portion 52 is longer than the width 51H of the front-end portion 51b.

Each hammering member 50 is fixed to the rod 30 so that a plurality of hammering members 50 are disposed between each rod-fixing member 40 as shown in FIG. 1. The hammering members 50 are attached to the rod 30 in rotatable manner around the rod 30. Owing to this arrangement, impact shock given to the hammering member at collision of the hammering member 50 against the target object to be powderized can be reduced. Also, fibers are prevented from being cut unnecessarily and thus the operation life of the hammering members can be elongated. Ordinarily, the front-end portion 51b of the hammering member 50 is oriented outward in the rotational radial direction due to the centrifugal force generated on the hammering member 50. Distance between the front-end portion 51b of the hammering member 50 and the inner wall of the cylindrical container 10 (refer to FIG. 2) is preferably set to approximately 1 to 20 mm. As a material for the hammering members 50 and the rods 30, for example, a metal material such as stainless steel can be mentioned.

As shown in FIG. 2, openings 42 are formed in each rod-fixing member 40 in an area where the rotational radius is smaller than at least the rotational radius of the rod 30 as viewed from the axial direction of the rotary shaft 20 so that gas or the like can flow therethrough in the axial direction.

Referring to FIG. 1, an inlet 14a for the target object is formed in the left side disk 14, and a screw feeder 70 is connected with the inlet 14a for supplying the target object. The screw feeder 70 comprises a cylinder 72, a screw 74 disposed within the cylinder 72, a motor 76 to rotate the screw 74 and a hopper 78 at one end of the cylinder 72 for supplying the target object. The other end of the cylinder 72 is connected to the inlet 14a for the target object.

As the target object supplied into the hopper 78, not particularly limited though, composite materials containing different kinds of materials can be mentioned, which include, for example, a plastic wall paper in which plastic layer of polyvinyl chloride or the like and backing paper (pulp fiber layer) are bonded with each other; and a tile carpet, a soundproofing sheet, a waterproofing sheet, a construction site safety net and the like in which a plastic layer of polyvinyl chloride or the like and a fiber layer of nylon or polyester are bonded with each other, or the fiber layer is sandwiched between plastic layers, or the fiber layer impregnated with resin and so forth. Particularly, composite materials including fibers and plastic layers are preferable. Also, a single element material can be powderized. Further, raw materials for medicine, food or the like, for example, dried tangle weed, mushrooms and the like can be powderized.

It is preferable that the target object to be supplied into the container 10 is fragmentized coarsely beforehand to 100 mm or smaller, preferably 10 mm or smaller. Configuration of the target object is not particularly limited, and a grained, chipped or sheet-like configuration may be accepted. The target object may include water content.

A plurality of gas inlets 14b are formed in the left disk 14. Each gas inlet 14b is arranged in a different position from each other in a rotational radial direction and each can supply gas such as air into the cylindrical container 10 respectively.

In a lower portion of a peripheral surface of the cylindrical container 10, an outlet 10b is formed. The front end of the outlet 10b is connected to a container 12 via a line L4.

A plurality of outlets 14c are provided in the right disk 14. Each outlet 14c is disposed in a different position from each other in a rotational radial direction. Each outlet 14c is provided with a bag filter 80 and a suction fan 82 via a line L2.

Discharging method from the outlets 10b and 14c is not limited to the above-described one. A screw feeder or the like may be used, or a natural discharging by the inside pressure of the container may be also applicable. It is possible to control the residence time by controlling the discharge speed of the powderized target object from the outlets 10b and 14c. Thus discharging the powderized target object from the outlet 10b and outlet 14c can realize a separate discharging into a light powder and a heavy powder, which is described later, and accordingly the powderizing apparatus of the present invention can also function as a separator. Three or more outlets may be provided and a single outlet may be formed when separation is not required. Also, in place of the outlet 10b, for example, as shown with a broken line in FIG. 1, an outlet 14d may be provided in an outermost portion in the right disk 14, and a bag filter 80 and a suction fan 82 may be provided via a line L5.

Now, a powderizing method using the powderizing apparatus 1 according to the embodiment will be described.

First of all, the rotary shaft 20 is driven to rotate. In this stage, it is preferable to set the circumferential speed of the hammering members 50 to a predetermined speed at the front end thereof as described above. Then, the gas such as air is supplied through the inlet 14b.

Then, the target object from the hopper 78 is supplied through the inlet 14a. The target object is rotated within the cylindrical container 10 by the hammering members 50 rotating at a high speed, and the target object performs rolling movement on the inner surface of the cylindrical container 10 due to the centrifugal force. Thus, the target object is swiftly powderized due to the collision with the hammering members 50 and the collision and friction with the inner wall of the cylindrical container 10 or the collision, friction and so on among the target objects themselves.

In this embodiment, since the rods 30 are disposed away from the rotary shaft 20 and closer to the inner wall of the cylindrical container 10, and the hammering members 50 are fixed to the rods 30, the length of hammering members 50 in the rotational radial direction can be satisfactorily reduced compared to the case where the hammering members 50 are fixed to the enlarged diameter portion 20a of the rotary shaft, and thereby the air resistance due to the rotation of the rotary shaft 20 can be reduced. Accordingly, it is easy to rotate the rotary shaft 20 at a high speed compared to the conventional way, and thus the target object can be swiftly powderized, for example, to 300 μm or smaller. And in the case where a composite material composed of different kind of materials is powderized, the target objects can be physically separated according to the kind of materials, for example, into resin powder and fibers. When the target object includes fiber materials such as paper and/or fabric, the fibers can be unraveled within the cylindrical container 10. Further, the electric power necessary for the rotation of the cylindrical container 10 can be reduced resulting in a power saving.

Moreover, within the cylindrical container 10, a strong centrifugal force acts on the powderized materials due to a high-speed rotation and light powder such as fibers or the like and heavy powder such as resin powder or the like are separated in the radial direction. That is, the light powder is separated in a central area in the radial direction; and the heavy powder is separated in the outer side in the radial direction. Since the openings 42 are formed in the rod-fixing members 40, the gas and the light powder can move in the axial direction. Particularly, since the rod 30 is disposed in a position closer to the inner wall of the cylindrical container 10 away from the rotary shaft 20, the openings 42 can be formed to be large enough, and therefore the light powder, which tends to gather inner side in the radial direction, can be easily discharged.

Therefore, the light powder, which is separated inner side in the radial direction, is discharged from the outlet 14c and captured by the filter 80, and the heavy powder, which is separated outer side in the radial direction, is discharged from the outlet 10b and captured by the bag filter 80. That is, the powderizing apparatus 1 also provides a function as a centrifugal separator. Since the outlets 14c and 14c are located away from each other in the rotational radial direction, the separation can be performed even between the bag filters 80 and 80.

The heavy powder, which is powderized as described above, for example, polyvinyl chloride resin powder can be suitably used as a regenerated polyvinyl chloride material such as a regenerated polyvinyl chloride compound. Also the light powder, for example, pulp can be used as a material for fleece wall paper, a soil conditioner or the like; and fibers can be used as a regenerated resin material.

Particularly, in the waste materials of composite resin, for example, in the case of polyvinyl chloride wall paper (polyvinyl chloride resin and plasticizer: approximately 40 wt %, filling material: approximately 20 wt %, and backing paper: approximately 40 wt %), only 1000 ton is recycled as a resource in total discharge amount of approximately 100,000 ton a year, which is one of the most difficult materials to recycle as a resource in the construction-waste materials. However, according to the above-described apparatus and the method, the polyvinyl chloride wall paper can be powderized to as small as 300 μm or less, and separated powder into resin compound powder composed of polyvinyl chloride resin, plasticizer and filling material, and fiber powder can be obtained. Further, owing to the centrifugal force, the powder can be separated into a heavy powder (for example, resin compound powder composed of polyvinyl chloride resin, plasticizer and filling material) and a light powder (pulp derived from backing paper), therefore the powder can be reused readily.

The present invention is not limited to the above-described embodiment, but various modifications are possible.

For example, the cylindrical container 10 may not be disposed in a perfectly horizontal direction but may be inclined to, for example, 30° or so. Also, the cylindrical container 10 may have a tapered shape.

The rods 30 also may not be perfectly parallel to the rotary shaft 20. For example, the rods 30 may be inclined by 10° or so in such a way that one end of the rods 30 is located closer to or away from the rotary shaft 20. Or, the rods 30 may be inclined by 10° or so in such a way that one end thereof is displaced in the rotational direction.

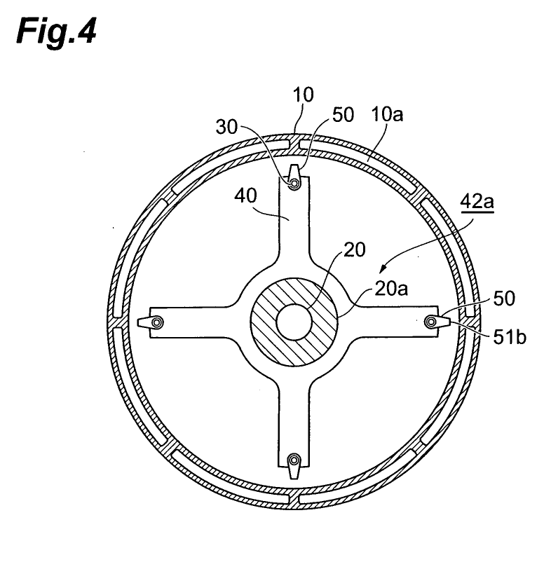

The configuration of the rod-fixing member 40 is not necessarily a frame-like one enclosing the rotary shaft 20 having openings 42. For example, as shown in FIG. 4, the rod-fixing member 40 may be structured so as to extend in a radial pattern from the rotary shaft forming cutouts 42a in an area where the rotational radius is shorter than that of the rods 30, enabling the gas to flow in the axial direction of the rotary shaft 20. It should be noted that the target object can be powderized to 300 μm or smaller without any openings or cutouts.

In addition, the hammering members do not always require such configuration as shown in FIG. 3(a). For example, the body portion 51 may have a plate-like shape as shown in FIG. 3(b); i.e., the length 51W in the axial direction may be smaller than the width 51H in the front-end portion 51b. The root portion 51a may have a cylindrical shape as shown in FIG. 3(c); i.e., the front end portion 51b may have a plate-like shape and one edge of the plate may be fixed to the pipe portion 52. The front-end portion 51b may have a rod-like shape as shown in FIG. 3(d). The body portion 51 may have a ring-like shape enclosing the pipe portion 52 and an inner part of the body portion 51 may be in contact with the outer periphery of the pipe portion 52 and fixed thereto in an eccentric manner as shown in FIG. 3(e). The body portion 51 may not have the pipe portion 52 but a through hole 51c may be formed in the body portion 51 as shown in FIG. 3(f). As shown in FIG. 3(g), additional blade portion may be formed on a face at the rotational direction side of the body portion 51 of FIG. 3(b).

It is possible to supply ions for eliminating static charge into the cylindrical container 10. The inner peripheral surface of the cylindrical container 10 may be ceramic-coated or formed with rugged surface.

The position of the outlet 10b in the axial direction is not particularly limited. Two or more outlets may be provided and selectively used depending on the object and/or operating conditions.

### EXAMPLE

Polyvinyl chloride wall paper of 1000 kg (resin compound composed of polyvinyl chloride resin, plasticizer and filling material: approximately 60 wt %, backing paper: approximately 40 wt %) was subjected to the powderizing processing using the apparatus shown in FIG. 1. The circumferential speed at the front end of the hammering members was set to 150 m/s.

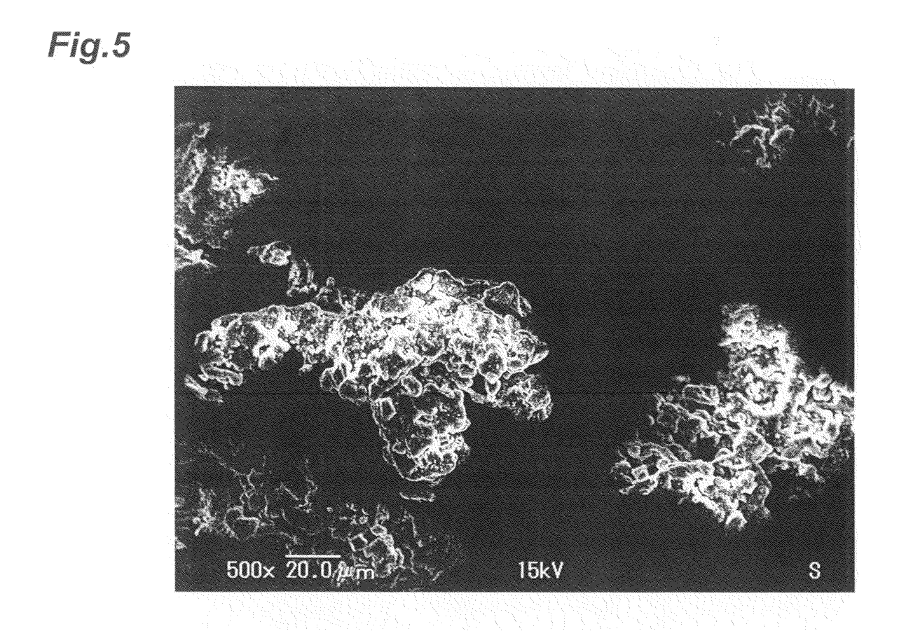

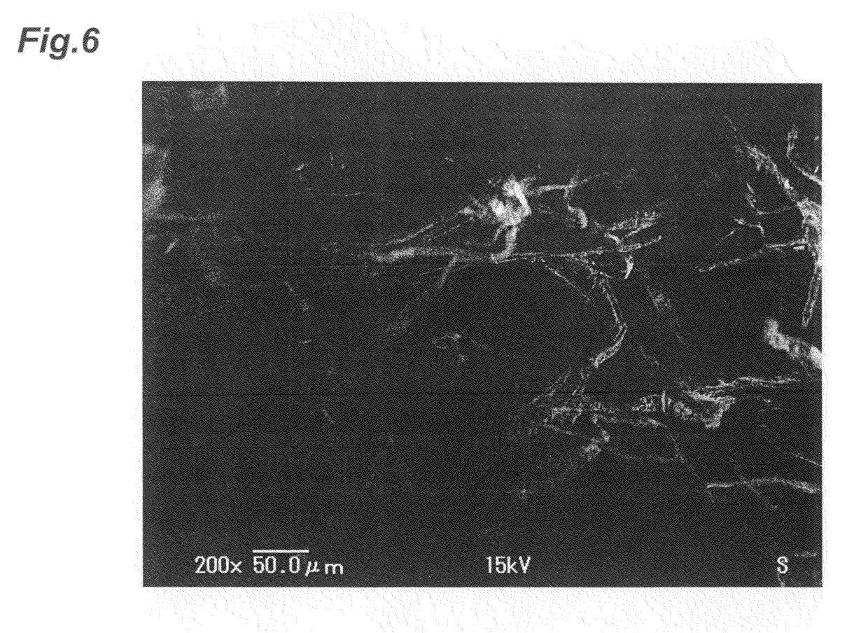

As a result, the polyvinyl chloride wall paper was powderized to 50 to 500 μm or so. The powder of 550 kg was collected by the container 12. The composition was resin compound powder composed of polyvinyl chloride resin, plasticizer and filling material was 90 wt %; and pulp was 10 wt %. The powder of 450 kg was collected by the bag filter 80, and the composition thereof was as follows; i.e., 20 wt % of resin compound powder composed of polyvinyl chloride resin, plasticizer and filling material, and the pulp was 80 wt %. These pulp powder and polyvinyl chloride resin compound powder had been mechanically separated already from each other. By further fine separation and classification processing using a sieve or the like, the resin compound powder of 300 μm or smaller and pulp filament of 1 to 3 mm in fiber length were obtained with a separation level of 99.5% or more. FIG. 5 shows a SEM photograph of the resin compound powder. FIG. 6 shows a SEM photograph of the pulp.

1. A powderizing apparatus, comprising:
a cylindrical container disposed in a substantially horizontal direction,
a rotary shaft disposed along an axis of the cylindrical container,
a plurality of rods disposed in substantially parallel with respect to the rotary shaft at a position away from the rotary shaft and close to an inner wall of the cylindrical container,
rod fixing members for fixing the plurality of rods to the rotary shaft, and
a plurality of hammering members provided to each of the rods.

2. The powderizing apparatus according to claim 1, wherein the rod-fixing member has a opening or a cutout in a portion where a rotational radius is smaller than at least that of the rods.

3. The powderizing apparatus according to claim 2, wherein plural outlets for powderized target object are provided respectively at positions where the distance from the rotary shaft is different from each other in the cylindrical container.

4. The powderizing apparatus according to claim 3, wherein, among the plural outlets, an outlet located at the largest distance from the rotary shaft is formed in a peripheral surface of the cylindrical container.

5. The powderizing apparatus according to claim 1, wherein the rotary shaft is rotated at a circumferential speed of 50 m/s or more, preferably 100 m/s or more, more preferably 120 m/s or more at a front end of the hammering members.

6. A powderizing method of powderizing target object using a powderizing apparatus according to claim 1.
